(19) United States
(12) Patent Application Publication
(10) Pub. No.: US 2008/0084076 A1
(43) Pub. Date: Apr. 10, 2008

(54) Guide tool

(76) Inventor: Jeffrey J. Van Sloun, Perrysburg, OH (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 11/546,111

(22) Filed: Oct. 10, 2006

(51) Int. Cl. B25J 1/04

(52) U.S. Cl. 294/19.1

(57) ABSTRACT

A flexible hand held guide tool for guiding materials such as wire and cable ties through obstructed areas such as pegboard, electrical components and automotive structures.

### FIELD OF THE INVENTION

This invention is a hand held tool used to guide materials such as wire, cable ties, also commonly know as “zip ties,” and the like through and around obstructions. The obstructions relate to holes in a pegboard, bunches of wire, electrical components and automotive structures. The need for guiding materials around and through obstructions is typically to attach, secure or add components to an existing application. More particularly in the peg board application, the addition of a cable tie to the pegboard around a pegboard hook provides stability thus keeping the peg from inadvertently becoming dislodged from the pegboard.

### BACKGROUND OF THE INVENTION

The invention has application in several different areas. Specifically, three are outlined; storage and display, electrical, and aftermarket automotive and repair.

Storage and display are commonly provided by the use of rigid sheets of hard board with a rectangular grid pattern of holes in equal distance both vertically and horizontally. These holes support hangers in the form of hooks and brackets that can be placed and removed in various locations on the board by engaging an anchoring element of the hanger with the selected hole or holes in the hardboard. Hangers for this use take many different forms and shapes determined by the material they will be supporting.

Typically, when the hooks are mounted onto the pegboard, the anchoring point is typically at the upper end of the device with an additional alignment pin at a lower point of the hanger that aligns with a lower hole in the pegboard. When properly attached to the pegboard, the weight of the hanger holds it in place. Additionally, the device placed on the hanger further holds to hanger in place due to the additional weight.

When devices are removed from the hanger the hanger will often release from the pegboard at the same time. This undesirable effect results from a combination of the angle the device is removed from the pegboard, the friction between the device and the hanger, or another part of the device lifting the hanger during the removal process. The same can happen while attempting to place a device upon a hanger. The displacement of the hangers in this manner is so undesirable that forms of stabilization have been provided for connecting hangers more securely to pegboards.

Electrical wiring for home security systems, irrigation systems, home entertainment systems and other industrial control systems are typically designed with connection points for multiple wires depending on the number of external devices connect to the system. As an example, a home security system has at least two wire connections for each window or series of windows protected. There may be a large number of these connections all of them requiring connection to insure their desired function.

These types of systems often require the addition of wires within and through large numbers of other existing wires. Placing these additional wires either involves the removal of existing wires, or the placement of the additional wire through force. Removing existing wires is time consuming and forcing a wire through others can break or weaken the existing wires compromising the entire electrical system.

Aftermarket automotive and repair applications often require the securing devices to the existing structure of the vehicle. These devices are various in nature but include such items and underbody lighting, fog lighting, hydraulic lifts, body molding and under carriage protection. The addition of these types of aftermarket equipment requires attachment in various locations with limited access.

Existing automotive wiring is typically held in place through the use of plastic injection molded fasteners that secure the wire press into a hole in the structure of the vehicle. These fasteners are often destroyed during repair or replacement.

The addition of aftermarket devices often involves the securing of wiring, hose, or cable to the vehicle structure. Methods for securing these devices have been provided that require welding, drilling, and various adhesives which are less desirable for the general population.

### SUMMARY OF THE INVENTION

The invention is directed to a tool that can be used to insert a flexible element. The tool has a handle and a guide that extends from the handle. The guide is shaped to position the flexible element in the desired location. A groove is positioned in the guide for receiving and directing the flexible element to the desired location.

### BRIEF DESCRIPTION OF THE DRAWINGS

FIG. 1 is a front view of the hand tool in the shape for peg board application.

FIG. 2 is a cross section of the groove in the guide section of the hand tool.

FIG. 3 is a fragmentary top view cut away of the pegboard application with the hand tool FIG. 1 inserted through the pegboard holes with the hanger in place and the cable tie inserted through the holes along the length of the hand tool guide.

FIG. 4 is a fragmentary perspective view of a completed pegboard application with the hook in place secured with a cable tie.

FIG. 5 is a fragmentary cutaway side view of a typical pegboard and hanger in place secured with a cable tie.

FIG. 6 is a fragmentary front view of FIG. 5.

FIG. 7 is a fragmentary cutaway side view of a typical pegboard and non-typical hanger requiring two cable tie fasteners to secure the hanger.

FIG. 8 is a fragmentary front view of FIG. 7.

FIG. 9 is a fragmentary top view of a hand tool FIG. 1 with a rounded guide being used to secure a bundle of wires together.

FIG. 10 is a fragmentary cutaway side view of a hand tool FIG. 1 with an open radius guide being used to secure a cable to a frame structure.

### DETAILED DESCRIPTION OF THE INVENTION

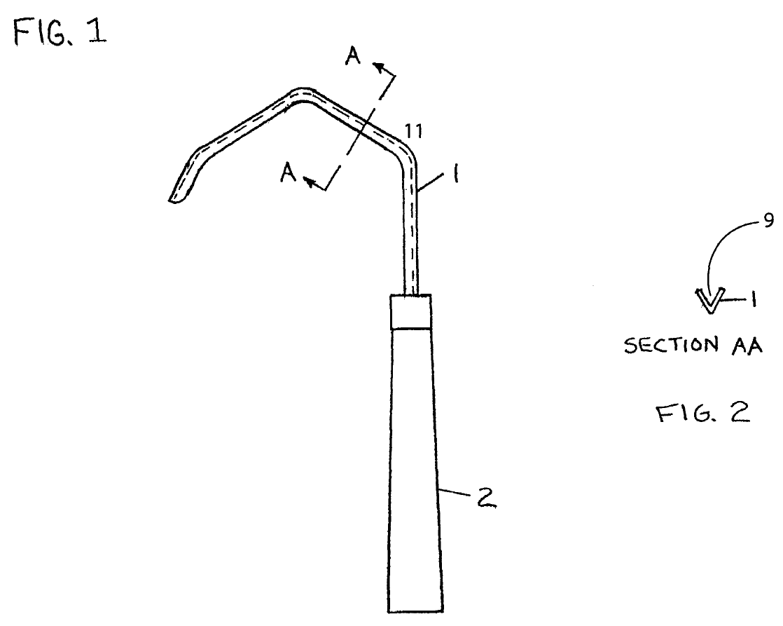

The tool consists of two components; guide 1 and handle 2 (FIG. 1). The guide 1 is constructed of metal such as brass, aluminum or plastic such as ABS or Styrene. The metal or plastic guide 1 is shaped to fit the specific application such as a pegboard 4, electrical wiring or automotive. Furthermore, the guide 1 is grooved 9 along the length in such a manner to accept a wire 16 or cable tie 5. The shape of the guide 1 is typically a series of arcs or radii which allow the guide 1 to be inserted thru or around an obstruction. In some cases the tool will be provided without shape (i.e. straight) so it can be bent or shaped by the end user to fit the specific application. The length of the guide 1 will be long enough to go around or thru the specific applications. Typically 4″-10″ in length. The groove 9 and guide 1 are sized such that it will be small enough to pass thru any holes that may be required. As an example, in the pegboard 4 application, the overall cross section of the groove must pass thru the pegboard 4 hole and allow enough space for the cable tie 5 to pass thru. The groove 9 in the guide 1 (FIG. 2) is shaped to accept the material being guided. It can be angular or round depending on the material or application. The handle 2 is comprised of wood or plastic and affixed to the end of the guide 1 thru friction and/or adhesive. The handle 2 allows for ease of maneuvering the tool. In addition, a magnet can be attached to the handle 2 to allow it to be placed while freeing the operator's hands to affix a cable tie 5 or guide a wire 16.

The tool will most commonly be used for the placement of “wire ties” or “zip ties” which are conventionally used to secure wire bundles, cables and harnesses. Various standard wire ties are commercially manufactured of plastic materials such as nylon. They are supplied in natural white or colors and may obtain certified load ratings depending on manufacture and application. Standard wire ties are covered under several U.S. patents and no claims about wire ties are made here.

In a typical pegboard 4 application, the pegboard 4 is of the type manufactured by the Masonite Corporation since the early 1960's. It is typically ⅛″-¼″ thick with ¼″ holes drilled both horizontally and vertically every one inch.

Typical hooks are manufactured by various suppliers from wire stock and various diameters from ⅛″- 3/16″ in numerous configurations involving one or more mounting points depending on the function of the hook 3. Hooks can also be made of plastic or other formable or moldable materials. Other devices that are commonly attached to peg boards are store displays such as shelves, book or magazine holders.

Electrical applications involve the guiding of individual wires thru other wires or electrical equipment within electrical enclosures. Often bundles of cables are placed in very tight proximity to the edges of these enclosures. In electrical applications, the guide 1 should be manufactured of non-conductive materials such as plastic. If high strength is required, the guide 1 can be manufactured from glass filled plastics such as polyester thru injection molding.

In automotive applications, devices, wires, tubes and vacuum lines are often secured to structures in the engine compartment under the dash and to the frame of the vehicle. The frame or structure being used to secure these devices is often restricted to push in tight fasteners due to limited access.

### Description of Peg Board Operation

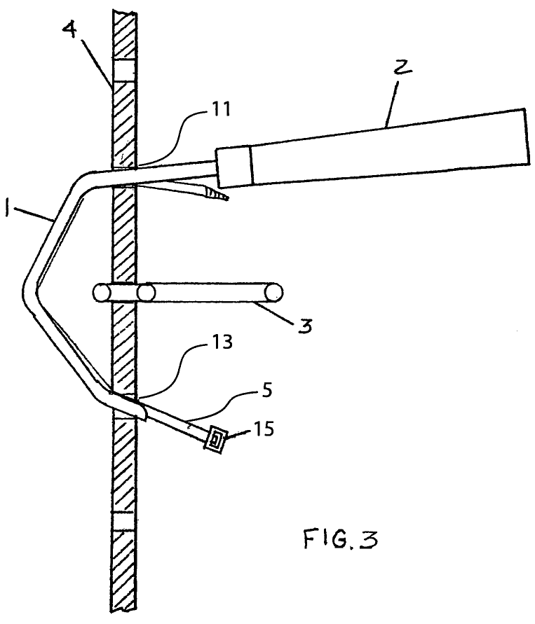

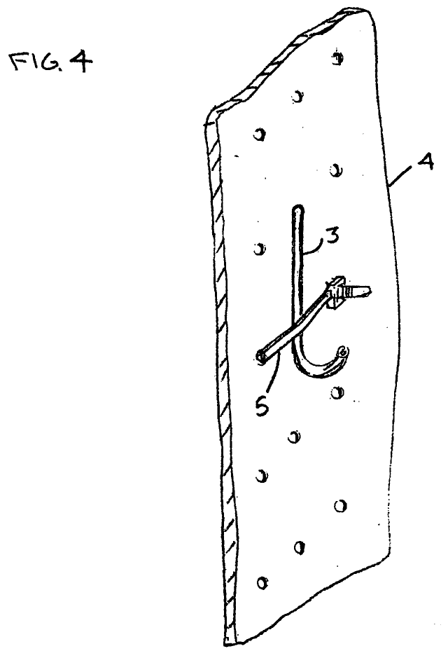

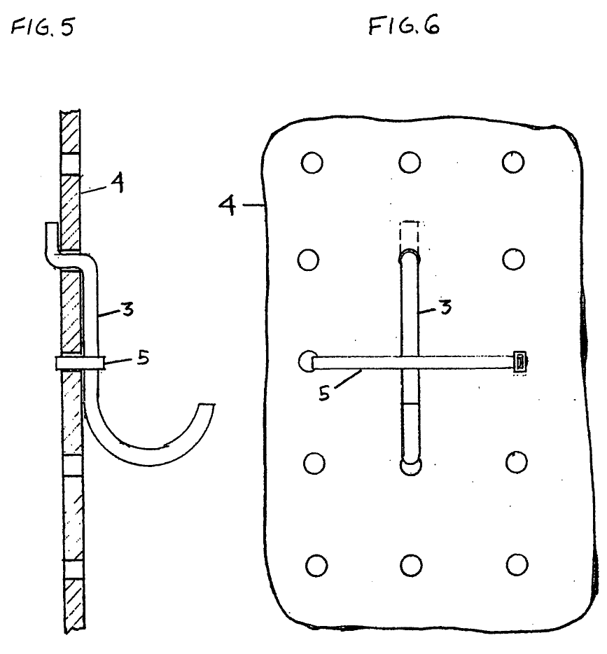

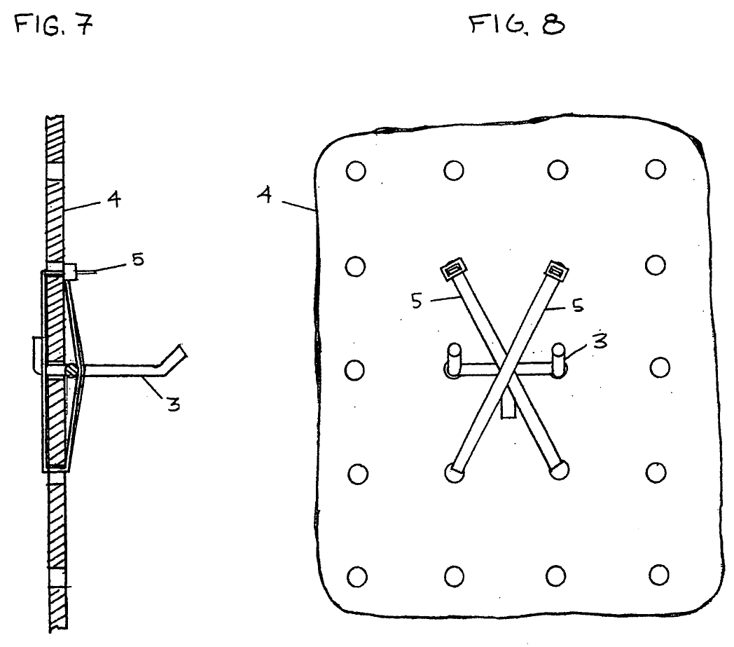

In the pegboard 4 application, the peg hook 3 is placed onto the pegboard 4 so that there is an open, accessible hole to the left and right of the hook 3 (FIG. 4). The guide 1 is held by its handle 2 and the end of the guide 1 is placed into either of the open holes in the pegboard 4. Using the handle 2 the guide 1 is fed thru the first hole 11 over to the opposite or second hole 13 where the end of the guide 1 extends back out of the pegboard 4 hole (FIG. 3). A cable tie 5 is then placed into the groove of the guide 1 opposite the handle 2 and slowly inserted into the hole so that it follows the groove in the guide 1 along the length and back out of the hole 13 closest to the handle 2. The cable tie 5 could alternatively be positioned in the groove 9 when the guide 1 is fed through the first hole 11 and second hole 13. The guide 1 is then removed. The large end 15 of the cable tie 5 retains it from pulling thru the hole in the pegboard 4 as the guide 1 is removed. The cable tie 5 can now be connected across the hook 3 and secured (FIG. 6). The hook 3 is now securely in place. Removal of the hook 3 requires severing the cable tie 5.

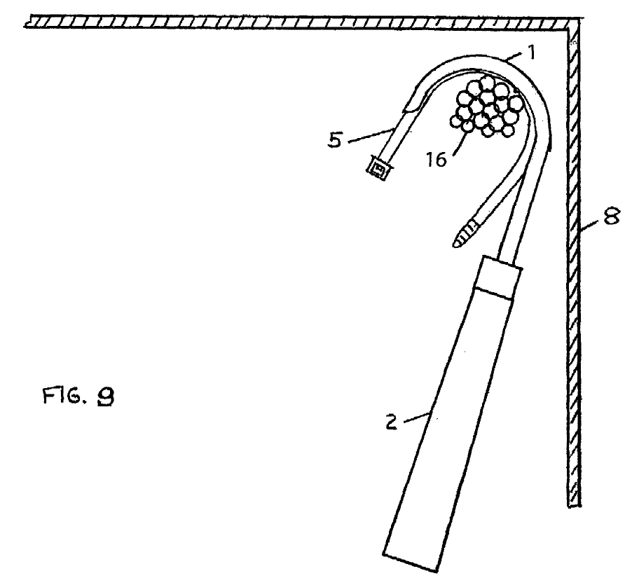

Some pegboard 4 hooks are not conducive to strapping in the manner described above. In those instances, the straps will be placed diagonally thru open holes adjacent to the hook 3 (FIG. 8). In addition, a second strap can be used depending on the specific application desired for the hook 3.

### Description of Use—Electrical Application

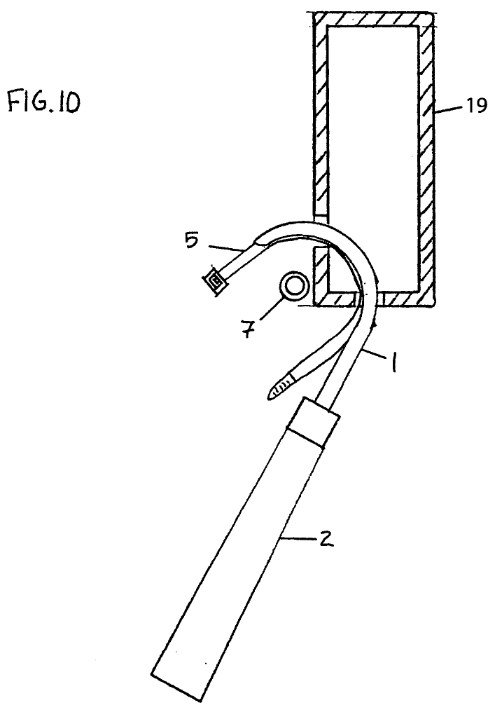

In electrical applications (FIG. 9), the guide 1 is used to tie bundles of wire 16 together and to fish individual wires thru wires and electrical equipment. The guide 1 is placed around the bundle of wires 16. The cable tie 5 is then placed into the groove of the guide 1 opposite the handle 2. The cable tie 5 is then inserted following the groove in the guide 1 toward the handle 2 end of the tool. The cable tie 5 can now be secured and the tool removed. The guide 1 can also be used to create a path thru a bundle of wires or equipment. Place the guide 1 at the point of entry for the wire 16 to be inserted. Insert the guide 1 along the desired path using the tip of the guide 1 to move the wires out of the way. When the guide 1 reaches the desired location, feed the wire 16 to be inserted into the groove from the handle 2 end of the groove. Continue inserting the wire 16 so that it follows the groove in the guide 1 along the length. Pull the wire 16 from the guide 1 at the end opposite the handle 2. Secure the wire 16 before removing the guide 1.

### Description of Use—Automotive

In Automotive applications (FIG. 10), there are many situations where access to the backside of structural parts is not available. The ability to fish a strap thru holes in the structure will allow items to be secured. Such as wiring harnesses 7 to the frame 19. In this example, the guide 1 is placed into the bottom hole on the frame and inserted holding to the handle 2 out thru the hole in the side of the frame 19. A cable tie 5 is then inserted into the groove at the opposite end of the guide 1 from the handle 2. It is continued to be inserted along the groove until it comes out of the frame 19 closest to the handle 2. The cable tie 5 can now be secured and the tool removed.

1. A tool for inserting flexible elements on a peg board having a plurality of holes to secure an object on the peg board comprising:
a handle;
a guide extending from the handle the guide having a first end connected to the handle and a second end spaced apart from the handle, the guide having a curved shape formed of a series of arcs to allow the guide to be inserted in a hole in the peg board, around a portion of the peg board and through another hole in the peg board, the guide having a first surface facing the handle and a second surface facing away from the handle; and
a groove positioned in the second surface of the guide for receiving the flexible element, the groove and guide directing the flexible element to the desired location in the holes and around the peg board whereby the flexible element can be used to secure an object to the peg board.

2. The tool of claim 1 wherein the guide is shaped to direct the flexible element to desired location.

3. (canceled)

4. The tool of claim 1 wherein the groove extends along the entire length of the second surface of the guide.

5. The tool of claim 1 wherein the flexible element is a plastic cable tie.

6. A method for inserting a flexible element through holes in an object and around a portion of the object comprising
placing a flexible element in a groove in a guide, the guide having a curved shape formed from a series of arcs;
positioning the guide in the hole in and around the object to position the flexible element in the desired location; and
removing the guide from the hole in and around the object while leaving the flexible element in the desired location.

7. The method of claim 6 in which the object is a peg board having a plurality of holes and the flexible element is positioned through at least two holes and around a portion of the peg board.

8. The method of claim 7 in which a hanger is positioned on the peg board and the flexible element is positioned to secure the hanger to the peg board.
